(19) United States
(12) Patent Application Publication
(10) Pub. No.: US 2025/0164520 A1
(43) Pub. Date: May 22, 2025

(54) Anchoring Structure for MEMS Accelerometers with Bend Offset Shift Rejection

(71) Applicant: InvenSense, Inc., San Jose, CA (US)

(72) Inventors: Xian HUANG, San Jose, CA (US); Varun Subramaniam Kumar, San Jose, CA (US); Eric Lautenschlager, Geneva, IL (US); Matthew Julian Thompson, Beaverton, OR (US); Mrigank Sharma, Milpitas, CA (US); Wenting Gu, Mountain View, CA (US)

(21) Appl. No.: 18/896,555

(22) Filed: Sep. 25, 2024

Related U.S. Application Data
(60) Provisional application No. 63/601,483, filed on Nov. 21, 2023.

(51) Int. Cl. G01P 15/08

(52) U.S. Cl. CPC G01P 15/0802

(57) ABSTRACT

A microelectromechanical system (MEMS) accelerometer includes a proof mass that translates outside of a MEMS device plane in response to a force of interest such as a z-axis linear acceleration. The proof mass is a component of a suspended spring-mass system that is anchored to both a cover substrate layer and a base substrate layer by an anchoring system. The anchoring system includes a central anchor that is mechanically anchored to only the cover layer, while two adjacent anchors are located at opposite sides of the central anchor and are anchored to at least the base substrate and have an electrical connection to processing circuitry of the base substrate. Compliant springs connect the central anchor to the two adjacent anchors in a manner such that the anchoring system absorbs applied stresses such as shear forces applied during system packaging, assembly, and during use in an end product.

### CROSS-REFERENCE TO RELATED APPLICATION

This application claims priority to U.S. Provisional Patent Application No. 63/601,483, filed Nov. 21, 2023, and entitled “Anchoring Structure for Z-axis MEMS Accelerometers with bend offset shift rejection,” which is incorporated by reference herein in its entirety for all purposes.

### BACKGROUND

Numerous items such as smart phones, smart watches, tablets, automobiles, aerial drones, appliances, aircraft, exercise aids, and game controllers may utilize sensors such as microelectromechanical system (MEMS) sensors during their operation. In many applications, various types of motion sensors such as accelerometers and gyroscopes may be analyzed independently or together in order to determine varied information for particular applications. For example, gyroscopes and accelerometers may be used in gaming applications (e.g., smart phones or game controllers) to capture complex movements by a user, drones and other aircraft may determine orientation based on gyroscope measurements (e.g., roll, pitch, and yaw), and vehicles may utilize measurements for determining direction (e.g., for dead reckoning) and safety (e.g., to recognizing skid or roll-over conditions).

As MEMS inertial sensors are increasingly utilized in ever more applications and devices, there is an ongoing need to improve the accuracy and consistency of MEMS sensor outputs. Many causes of inaccuracy in a MEMS inertial sensor are caused not by the design or manufacturing process of the MEMS inertial sensor, but rather by forces that are imparted on the MEMS inertial sensor during assembly with other components of an end use device or during usage of an end use device. As an example, a variety of forces such as compressive and shear forces may be applied to one or more layers of the MEMS inertial sensor such as via a cover substrate layer and/or a base substrate layer. These forces are translated to the operative MEMS layer of the MEMS inertial sensor and may cause a shift in the stationary position of components such as a proof mass, resulting in an undesired offset signal that obscures or modifies the measured signal in response to the force of interest. Such an offset may be particularly acute in the case of shear or bend forces applied to the MEMS layer of an out-of-plane (e.g., z-axis) accelerometer.

### SUMMARY

In an embodiment of the present disclosure, a microelectromechanical system (MEMS) sensor comprises a cover substrate; a base substrate, a first anchor coupled to the cover substrate, a plurality of second anchors coupled to the base substrate, and a suspended spring-mass system within a MEMS layer positioned between the base substrate and cover substrate. The suspended spring-mass system comprises a proof mass, a first anchoring portion coupled to the cover substrate via the first anchor, a second anchoring portion coupled to the base substrate via a first one of the plurality of second anchors, and a third anchoring portion coupled to the base substrate via a second one of the plurality of second anchors, wherein the second anchoring portion and third anchoring portion are located on opposite sides of the first anchoring portion. The suspended spring-mass system further comprises a first compliant spring connecting first anchoring portion to the second anchoring portion, a second compliant spring connecting the first anchoring portion to the third anchoring portion, and a plurality of shock absorption springs coupled between the first anchoring portion and the proof mass.

In an embodiment of the present disclosure, a microelectromechanical system (MEMS) sensor comprises a cover substrate, a base substrate, a first anchor coupled to the cover substrate, a plurality of second anchors coupled to the base substrate, and a suspended spring-mass system within a MEMS layer positioned between the base substrate and cover substrate. The suspended spring-mass system comprises a proof mass suspended from the first anchor and second anchor via one or more springs, a first anchoring portion coupled to the cover substrate via the first anchor, a second anchoring portion coupled to the base substrate via a first one of the plurality of second anchors, and a third anchoring portion coupled to the base substrate via a second one of the plurality of second anchors, wherein the second anchoring portion and third anchoring portion are located on opposite sides of the first anchoring portion. The suspended spring-mass system further comprises a first compliant spring of the one or more springs surrounding the second anchoring portion and connecting first anchoring portion to the second anchoring portion, and a second compliant spring of the one or more springs surrounding the third anchoring portion and connecting the first anchoring portion to the third anchoring portion.

In an embodiment of the present disclosure, a microelectromechanical system (MEMS) sensor comprises a cover substrate, a base substrate, a first anchor coupled to the cover substrate, a plurality of second anchors coupled to the base substrate, and a suspended spring-mass system within a MEMS layer positioned between the base substrate and cover substrate. The suspended spring-mass system comprises a proof mass, a first anchoring portion coupled to the cover substrate via the first anchor, a plurality of second anchoring portions coupled to the base substrate via a respective one of the plurality of second anchors, a shear reduction means for isolating the first anchoring portion from a shear force at the plurality of second anchoring portions, and a shock absorption means located between the first anchoring portion and the proof mass for absorbing a shock force at the first anchoring portion.

### BRIEF DESCRIPTION OF DRAWINGS

The above and other features of the present disclosure, its nature, and various advantages will be more apparent upon consideration of the following detailed description, taken in conjunction with the accompanying drawings in which:

FIG. 1 shows an illustrative MEMS system in accordance with an embodiment of the present disclosure;

FIG. 2A depicts a top view of a MEMS layer of an exemplary out-of-plane accelerometer in accordance with an embodiment of the present disclosure;

FIG. 2B depicts a top view of an anchoring system of the MEMS layer of the exemplary out-of-plane accelerometer of FIG. 2A in accordance with an embodiment of the present disclosure;

FIG. 2C depicts a cross sectional view of the exemplary out-of-plane accelerometer of FIG. 2A in accordance with an embodiment of the present disclosure;

FIG. 2D depicts a cross sectional view of the exemplary out-of-plane accelerometer of FIG. 2A subject to a shear force in accordance with an embodiment of the present disclosure;

FIG. 2E depicts a top view of an anchoring system of the MEMS layer of the exemplary out-of-plane accelerometer of FIG. 2A subject to the shear force of FIG. 2D in accordance with an embodiment of the present disclosure;

FIG. 2F depicts a top view of an anchoring system of the MEMS layer of the exemplary out-of-plane accelerometer of FIG. 2A subject to a shock force in accordance with an embodiment of the present disclosure;

FIG. 3A depicts a top view of another exemplary anchoring system of a MEMS layer of an exemplary out-of-plane accelerometer in accordance with an embodiment of the present disclosure;

FIG. 3B depicts a cross sectional view of the exemplary out-of-plane accelerometer including the anchoring system of FIG. 3A in accordance with an embodiment of the present disclosure; and

FIG. 4 depicts exemplary steps of operating an out-of-plane accelerometer having offset shift rejection in accordance with an embodiment of the present disclosure.

### DETAILED DESCRIPTION

A MEMS sensor such as a MEMS accelerometer includes a proof mass that is fabricated within a MEMS layer such that it responds to a force of interest such as a linear acceleration. Although the present disclosure will be described in the context of a MEMS accelerometer, it will be understood that the anchoring and spring systems of the present disclosure may be applied to other MEMS sensors with suspended proof masses, such as gyroscopes, pressure sensors, magnetometers or microphones. The proof mass is mechanically suspended such as by a series of springs and masses such that it moves in a particular manner and direction to be responsive to a linear acceleration in a particular direction (e.g., along the x-axis, y-axis, or z-axis). Collectively, the components of the MEMS layer that are suspended within the MEMS layer and that are anchored at anchoring regions, and including those anchoring regions, are referred to herein as a suspended spring-mass system. In the described embodiments, proof masses that primarily translate within the MEMS plane relative to fixed sense electrodes are referred to as in-plane proof masses while masses that primarily move out of plane (e.g., by rotating or plunging) in the direction of another layer of the sensor (e.g., a base substrate and cover substrate) relative to fixed sense electrodes on the other layer(s) are referred to as out-of-plane proof masses. Although these proof masses are configured to move in a particular manner, external forces such as shear forces (e.g., due to packaging or use in end-use devices) and shock forces (e.g., dropping an end-use device including the sensor or other physical impacts) may permanently impact the MEMS accelerometer's performance, for example, by shear forces changing an expected position of the proof mass with respect to a sense electrode or by shock forces damaging proof masses or springs that change the response of the proof mass to the force of interest.

The MEMS layer may be rigidly anchored to the base substrate and/or the cover substrate to suspend the active components within of the MEMS layer within the MEMS layer and to provide electrical signal paths to the MEMS layer (e.g., from a base substrate including processing circuitry). In an embodiment of the present disclosure, a mechanical anchoring portion is mechanically anchored to only one of the substrates (e.g., the cover substrate) while one or more electrical anchoring portions is at least electrically anchored to the other substrate (e.g., the base substrate) and may also be mechanically anchored to the same substrate as the mechanical anchoring portion. In the series of springs and masses that interconnect the components of the MEMS layer, the mechanical anchoring portion is located more proximate to the proof mass than the electrical anchoring portions, and between the electrical anchoring portions and the proof mass.

A compliant spring is located between the electrical anchoring portions and the mechanical anchoring portions. In an example, an electrical anchoring portion is located on each side of the mechanical anchoring portion equidistant to the mechanical anchoring portion. The compliant spring is relatively thin and extends from a far side of each electrical anchoring portion furthest from the mechanical anchoring portion, surrounds and extends around the electrical anchoring portion, and attaches to the mechanical anchoring portion at the other side. When a force such as a shear force is experienced by the package of the MEMS accelerometer, for example on the cover substrate and base substrate that the MEMS layer is connected to via anchors, the compliant springs isolate the movement of the electrical anchor from the mechanical anchor, including in some instances allowing the electrical anchoring portions to tilt within the MEMS layer while the mechanical anchoring portion only translates within the MEMS layer. In this manner, the distance of the proof mass with respect to a sense electrode (e.g., such as an out-of-plane sense electrode) does not change even when a severe shear force is applied to the sensor package.

Shock absorption springs are also located between the mechanical anchoring portion and the proof mass. For example, multiple shock absorption springs may extend out from a centrally located mechanical anchoring portion and may be defined by a number of slots within the MEMS layer in which material has been removed. The sizing of the shock absorption springs is relatively long compared to their width, and slots are positioned to the side and in line with the shock absorption springs. Accordingly, when a shock force is applied to the sensor package, the shock absorption springs flex within the allotted space of the adjacent slots, preventing translation of this force from the packaging (e.g., the base and/or cover substrates) to the proof mass via the anchors to the packaging.

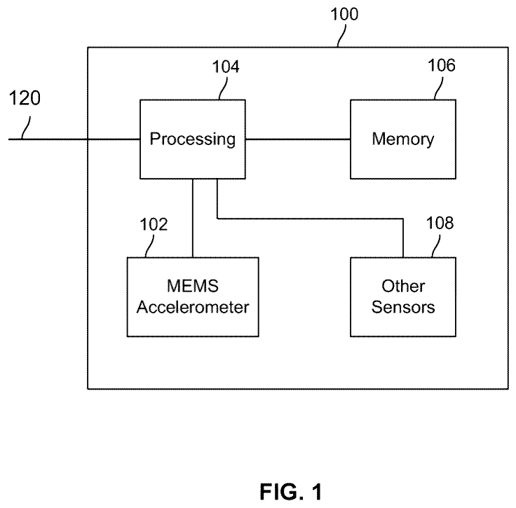

FIG. 1 shows an illustrative MEMS system 100 in accordance with an embodiment of the present disclosure. Although particular components are depicted in FIG. 1, it will be understood that other suitable combinations of the MEMS, processing components, memory, and other circuitry may be utilized as necessary for different applications and systems. In accordance with the present disclosure, the MEMS system may include a MEMS accelerometer 102 such as a z-axis accelerometer having a proof mass that moves out-of-plane in response to a z-axis acceleration, as well as additional sensors 108 such as additional MEMS accelerometers, MEMS gyroscope(s), MEMS pressure sensors, and additional MEMS or other sensors.

Processing circuitry 104 may include one or more components providing processing based on the requirements of the MEMS system 100. In some embodiments, processing circuitry 104 may include hardware control logic that may be integrated within a chip of a sensor (e.g., on a base substrate of a MEMS accelerometer 102 and/or other sensors 108, or on an adjacent portion of a chip to the MEMS accelerometer 102 or other sensors 108) to control the operation of the MEMS accelerometer 102 or other sensors 108 and perform aspects of processing for the MEMS accelerometer 102 or the other sensors 108. In some embodiments, the MEMS accelerometer 102 and other sensors 108 may include one or more registers that allow aspects of the operation of hardware control logic to be modified (e.g., by modifying a value of a register). In some embodiments, processing circuitry 104 may also include a processor such as a microprocessor that executes software instructions, e.g., that are stored in memory 106. The microprocessor may control the operation of the MEMS accelerometer 102 by interacting with the hardware control logic and processing signals received from MEMS accelerometer 102. The microprocessor may interact with other sensors 108 in a similar manner. In some embodiments, some or all of the functions of the processing circuitry 104, and in some embodiments, of memory 106, may be implemented on an application specific integrated circuit (“ASIC”) and/or a field programmable gate array (“FPGA”).

Although in some embodiments (not depicted in FIG. 1), the MEMS accelerometer 102 or other sensors 108 may communicate directly with external circuitry (e.g., via a serial bus or direct connection to sensor outputs and control inputs), in an embodiment the processing circuitry 104 may process data received from the MEMS accelerometer 102 and other sensors 108 and communicate with external components via a communication interface 110 (e.g., a serial peripheral interface (SPI) or I2C bus, in automotive applications a controller area network (CAN) or Local Interconnect Network (LIN) bus, or in other applications a suitably wired or wireless communications interface as is known in the art). The processing circuitry 104 may convert signals received from the MEMS accelerometer 102 and other sensors 108 into appropriate measurement units (e.g., based on settings provided by other computing units communicating over the communication interface 110) and perform more complex processing to determine measurements such as orientation or Euler angles, and in some embodiments, to determine from sensor data whether a particular activity (e.g., walking, running, braking, skidding, rolling, etc.) is taking place. In some embodiments, some or all of the conversions or calculations may take place on the hardware control logic or other on-chip processing of the MEMS accelerometer 102 or other sensors 108.

In some embodiments, certain types of information may be determined based on data from multiple MEMS gyroscopes 102 and other sensors 108 in a process that may be referred to as sensor fusion. By combining information from a variety of sensors it may be possible to accurately determine information that is useful in a variety of applications, such as image stabilization, navigation systems, automotive controls and safety, dead reckoning, remote control and gaming devices, activity sensors, 3-dimensional cameras, industrial automation, and numerous other applications.

In embodiments of the present disclosure, a MEMS sensor such as a MEMS accelerometer (e.g., an out-of-plane z-axis accelerometer, or an in-plane x-axis or y-axis accelerometer) has an anchoring structure that absorbs externally applied forces to prevent such forces from impacting the stationary position of relevant sensing structures such as one or more proof masses that are configured to move in response to acceleration in a particular direction with respect to fixed sense electrodes (e.g., out-of-plane for a z-axis accelerometer or in-plane for a x-axis or y-axis accelerometer). The anchoring structure includes compliant springs that absorb externally applied shear or lateral forces, for example due to respective laterally applied forces (e.g., in opposite directions, or applied to only one of the cover or base substrate) on a cover (e.g., cap or lid) substrate and a base (e.g., bottom, processing, or CMOS) substrate, such as may be occur during manufacturing and packaging of the MEMS accelerometer 102, integration of the MEMS accelerometer 102 in an end-use product, or during use of the end-use product. The anchoring structure also includes shock absorption springs that absorb forces due to shocks such as during use in an end-use product or when the end-use product is dropped or otherwise experiences relatively short duration, high-force events. The shock absorption springs are located between a primary mechanical anchor and a proof mass of the MEMS accelerometer such that shock forces are absorbed within the anchoring structure and are not mechanically transmitted to the proof mass.

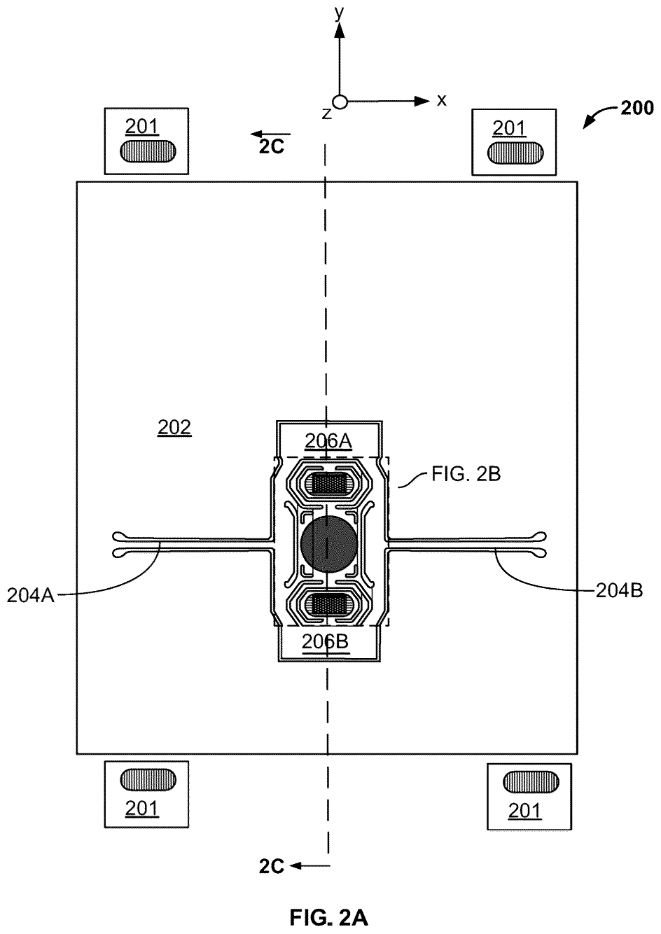

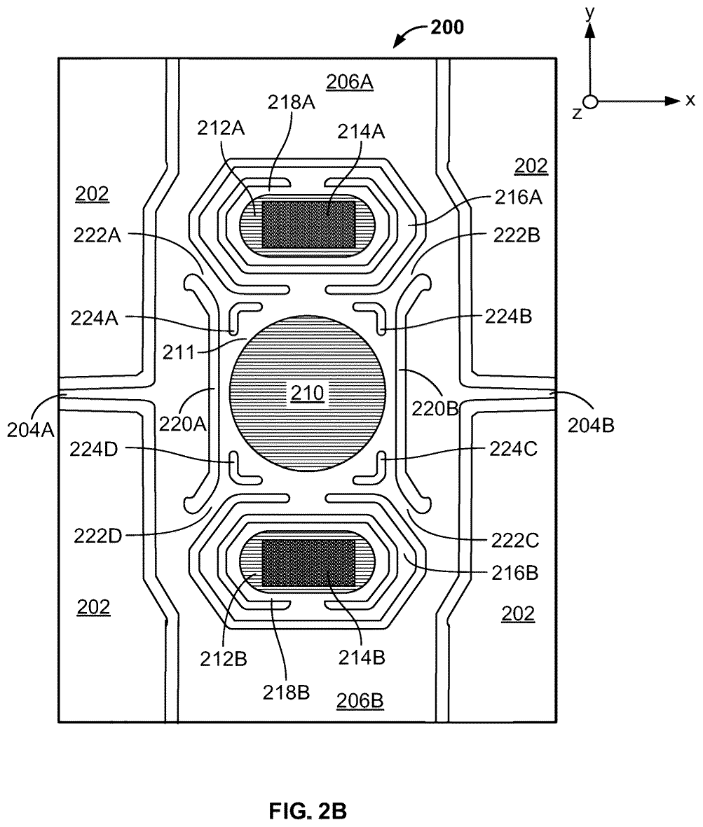

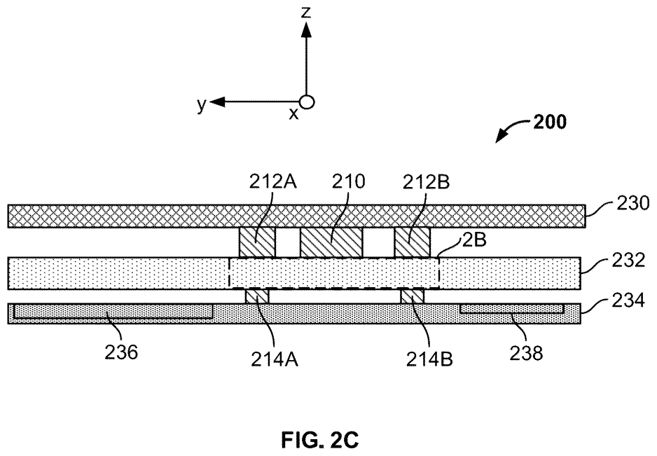

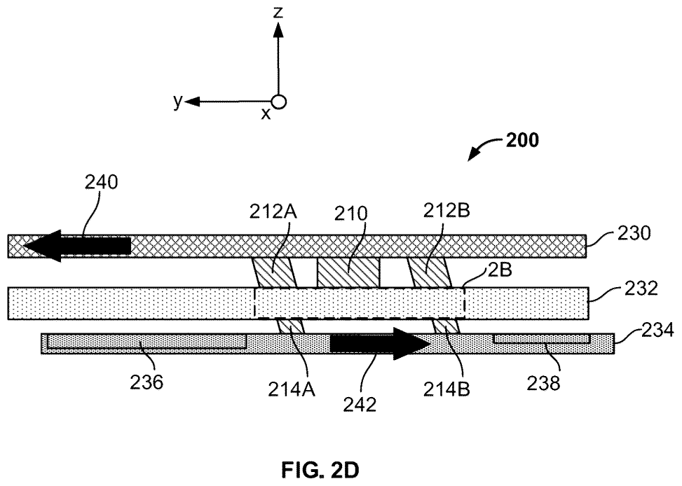

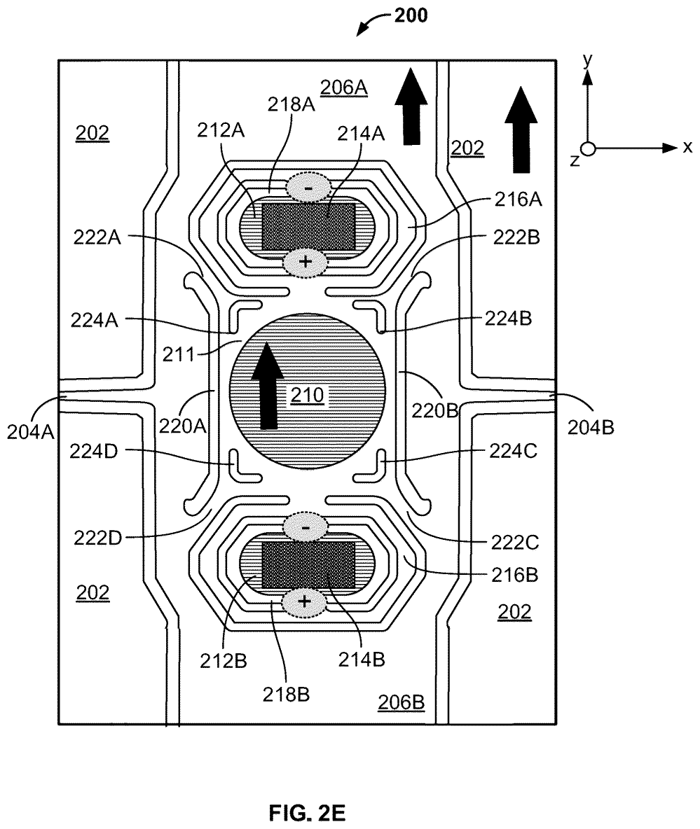

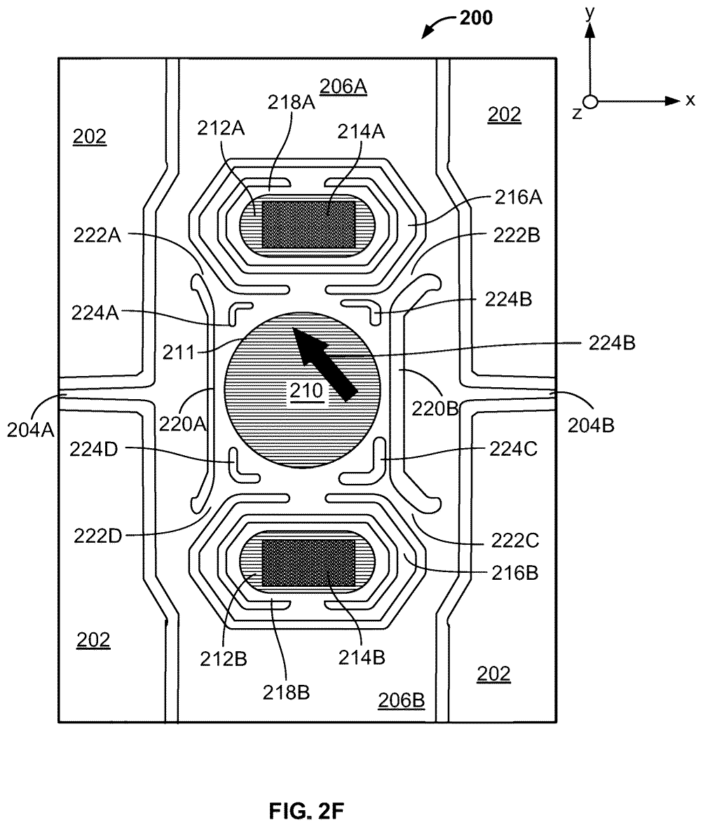

FIG. 2A depicts a top view of a MEMS layer of an exemplary out-of-plane accelerometer in accordance with an embodiment of the present disclosure. Although FIG. 2 will be described in the context of a particular application and system components including a z-axis MEMS accelerometer having an out-of-plane proof mass located within a MEMS layer of a three-layer MEMS sensor architecture, it will be understood that the anchoring system of the present disclosure may be utilized with a variety of other sensors such as MEMS gyroscopes and in-plane sensing (e.g., x-axis or y-axis) MEMS accelerometers to prevent shear and shock forces from impacting the stationary position of a proof mass. As another example, while the present disclosure will be discussed in the context of a MEMS structure including three primary structural layers (e.g., a cover substrate, a base substrate, and a MEMS layer bonded between the cover substrate and base substrate), in some embodiment other MEMS sensor configurations (e.g., with intervening and/or integrated layers) may utilize the anchoring structure of the present disclosure (e.g., with mechanical anchoring of the MEMS layer to one layer or substrate and electrical anchoring to another layer or substrate).

In the exemplary embodiment of FIG. 2A, the MEMS accelerometer includes an anchoring system or system (e.g., as is further depicted in FIG. 2B), fixed MEMS layer portions 206A and 206B adjacent and coupled to the anchoring system, proof mass 202, sense springs 204A and 204B coupled between the anchoring system and proof mass 202, and fixed regions 201. In addition, section line 2C depicts a section line corresponding to FIG. 2C and its accompanying description. Although these particular components are depicted and described in FIG. 2A, it will be understood that components may be added, removed, substituted, or modified in accordance with the present disclosure. For example, in some embodiments a fixed MEMS layer portion may not be included within the MEMS layer, or may be located in a position that is remote from the shock absorption spring (e.g., that is not partially adjacent the shock absorption springs depicted in more detail in FIG. 2B and the sense springs of FIG. 2A).

In the embodiment of FIG. 2A, each of two fixed MEMS layer portions 206A and 206B extend from the anchoring system 2B as a continuous layer of material such that the fixed MEMS layer portions are integral with the anchoring system. In this manner, movements of the anchoring system due to externally applied forces, such as lateral movement within the MEMS layer, are also translated to the fixed MEMS layer portions 206A and 206B. In the context of the present disclosure, the anchoring system 2B prevents the external forces (such as shear forces) from tilting the entirety of the anchoring system, such that a portion of the anchoring system that connects to the fixed MEMS layer portions 206A and 206B does not tilt out of plane in response to the force, and thus the fixed MEMS layer portions 206A and 206B do not tilt out of plane either. The fixed MEMS layer portions are stationary in response to a force of interest. It will be noted that although a particular number of fixed MEMS layer portions 206A and 206B are depicted in FIG. 2A having a particular shape and configuration, other numbers of fixed MEMS layer portions, configurations, and shapes may be utilized consistent with the present disclosure, for example, by fixedly connecting such fixed MEMS layer portions within the MEMS layer to the portion of the anchoring system 2B that is isolated from external forces (e.g., shear forces) via compliant springs as described herein.

The anchoring system 2B is also connected to the proof mass 202 via respective suspension springs 204A and 204B, which extend within the MEMS layer through a portion of the proof mass 202 and are torsionally compliant (e.g., about the x-axis) to allow the proof mass 202 to rotate out of plane in response to a z-axis linear acceleration. Sense electrodes (not depicted in FIG. 2A) are located below the proof mass (e.g., below upper and lower portions of the proof mass) to form capacitive sensors (e.g., differential sensors) with the proof mass 202. It will be understood that the depicted configuration of proof mass 202 and suspension springs 204A and 204B is exemplary only, and that a variety of proof mass, spring, and other configurations may be utilized to allow the proof mass to move out of plane in response to a z-axis linear acceleration. In the context of the present disclosure, the proof mass is connected (e.g., by springs) within the MEMS layer to the portion of the anchoring system 2B that is isolated from external forces (e.g., shear forces) via compliant springs as described herein.

FIG. 2B depicts a top view of an anchoring system of the MEMS layer of the exemplary out-of-plane accelerometer of FIG. 2A in accordance with an embodiment of the present disclosure. Although an anchoring system as described herein may be implemented with a variety of components and configurations, and components may be modified, omitted, or added in different embodiments consistent with the present disclosure (e.g., while maintaining isolation of the mechanically anchored portion(s) from the electrically anchored portion(s) via compliant springs, and/or providing shock absorption springs between the mechanically anchored portion(s) and the active components of the MEMS layer), in an embodiment the anchoring system 2B may include a mechanical anchor 210, a mechanical anchoring portion 211, mechanical anchors 212A and 212B, electrical anchors 214A and 214B, compliant springs 216A and 216B, electrical anchoring portions 218A and 218B, isolation slots 220A and 220B, shock absorption springs 222A/222B/222C/222D, and shock absorbing slots 224A/224B/224C/224D. In the embodiment of FIG. 2B, the shock absorption springs 222A/222B/222C/222D, and shock absorbing slots 224A/224B/224C/224D are each located equidistant from the mechanical anchor 210.

Mechanical anchoring portion 211 is anchored to another layer of the MEMS accelerometer (e.g., the cover substrate) via mechanical anchor 210, which in the embodiment of FIG. 2B is a circular anchor that mechanically attaches and suspends the mechanical anchoring portion 211 of the MEMS layer to the cover substrate. The mechanical anchoring portion 211 is not connected to the base substrate, and thus its position within the MEMS package of the MEMS accelerometer is primarily based on the position of the cover substrate. Although mechanical anchor 210 is depicted as circular in FIG. 2B and is depicted as having particular proportions relative to the mechanical anchoring portion 211 and other components of the anchoring system, it will be understood that the mechanical anchor may be implemented in a variety of shapes and sizes as appropriate to provide for robust mechanical suspension of the MEMS layer. While the mechanical anchoring portion 211 is depicted has having a generally rectangular shape and relative proportions with respect to other components of the anchoring system, it will be understood that the mechanical anchoring portion may be implemented in a variety of manners (e.g., shapes such as ovals, circles, squares, polygons, irregular shapes; differing sizes; etc.) in accordance with the present disclosure. Further, although a single mechanical anchoring portion 211 is depicted in FIG. 2B, it will be understood that multiple mechanical anchoring portions 211 may be utilized and located at different locations within the anchoring system, while maintaining isolation from shear forces via appropriately located and configured compliant springs and shock absorption via appropriately located and configured shock absorption springs.

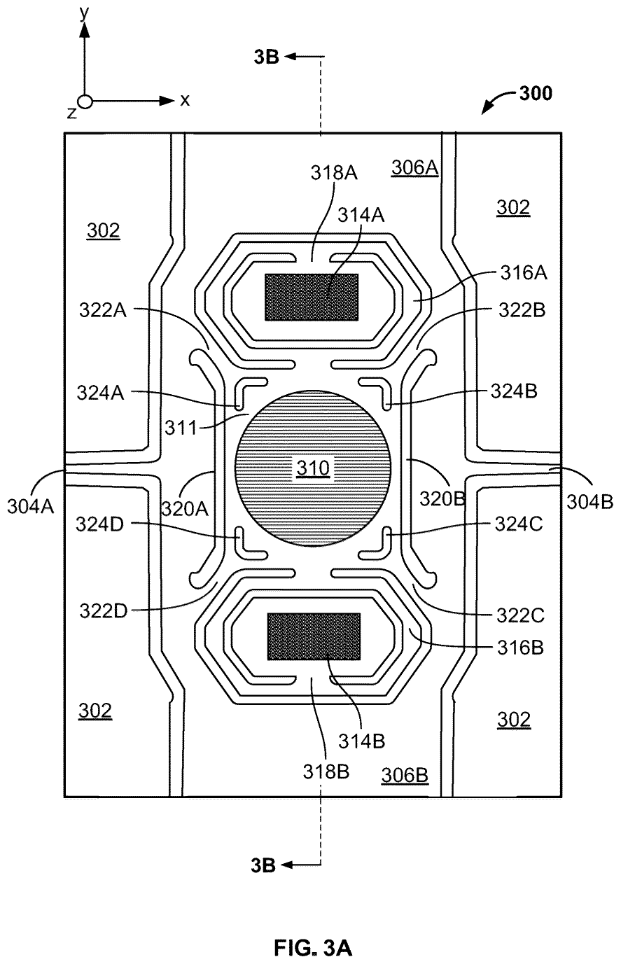

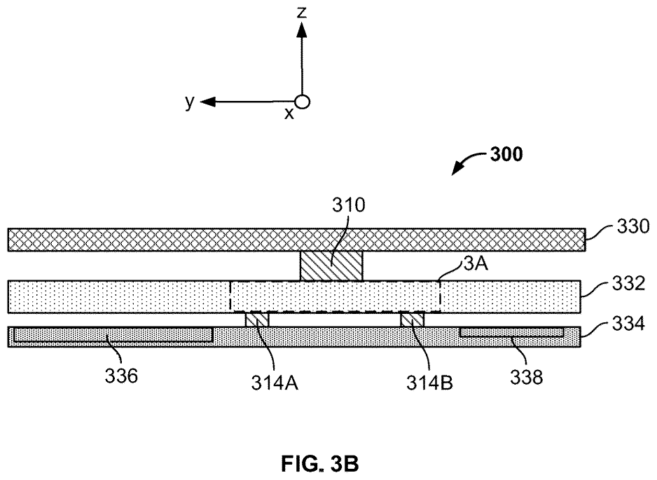

In the exemplary embodiment of FIG. 2B, electrical anchoring portions 218A and 218B are located on each side of mechanical anchoring portion 211, and are equidistant from the mechanical anchoring portion 211. In other embodiments, different numbers of electrical anchoring portions 218A and 218B may be utilized, and the electrical anchoring portions may be located at a variety of relative positions with respect to one or more mechanical anchoring portions, while maintaining isolation of externals forces based on configuration and location of compliant springs. Each of the electrical anchoring portions 218A and 218B is anchored to a base substrate that includes electrical including processing circuitry such as CMOS circuitry via a respective electrical anchor 214A and 214B. In the embodiment of FIG. 2B, the electrical anchoring portions 218A and 218B are also mechanically anchored to the cover substrate via mechanical anchors 212A and 212B, although in some embodiments (e.g., as depicted in FIGS. 3A and 3B) the electrical anchoring portions 218A and 218B may not include the mechanical anchors. While the electrical anchoring portions 218A and 218B are depicted has having a generally oval or polygon shape and relative proportions with respect to other components of the anchoring system, it will be understood that the electrical anchoring portions may be implemented in a variety of manners (e.g., shapes such as rectangles, circles, squares, polygons, irregular shapes; differing sizes; etc.) in accordance with the present disclosure.

Compliant springs 216A and 216B connect between the mechanical anchoring portion 211 and the respective electrical anchoring portions 218A and 218B. In the embodiment depicted in FIG. 2B, each compliant spring 216A and 216B connects to a side of the electrical anchoring portion 218A or 218B that is opposite from mechanical anchoring portion 211 along the y-axis, providing a surrounding portion that surrounds the respective electrical anchoring portion 218A or 218B, and connects to the mechanical anchoring portion 211 closer to the mechanical anchoring portion 211 along the y-axis. The width of the compliant springs 216A and 216B within the MEMS plane (i.e., x-y plane) is relatively thin compared to the dimensions of the anchoring portions, such that the compliant spring flex both in plane and out of plane when the position of the electrical anchoring portions 218A and 218B shifts with respect to the mechanical anchoring portion, for example, in response to a shear force. Although the compliant springs 216A and 216B are depicted is extending from the side of the electrical anchoring portion 218A or 218B opposite the mechanical anchoring portion 211, and extending to surround the electrical anchoring portion 218A or 218B and attach at the other side to the mechanical anchoring portion 211, it will be understood that other configurations may similarly facilitate isolation of external forces between the electrical and mechanical anchoring portions.

Shock absorption springs 222A/222B/222C/222D connect at one end to the mechanical anchoring portion 211 and the opposite end to a relatively thick interconnecting MEMS layer portion that in turn connects to the fixed MEMS layer portions 206A and 206B and to the suspension springs 204A and 204B. The suspension springs 204A and 204B in turn connect to the proof mass 202 (not depicted in FIG. 2B), and in this manner the proof mass 202 is suspended from the mechanical anchor 210 via the mechanical anchoring portion 211 and intervening shock absorption springs 222A and 222B. The shock absorption springs 222A/222B/222C/222D are defined by isolation slots 220A and 220B, shock absorbing slots 224A/224B/224C/224D, and the slots of the adjacent (e.g., separated by a slot without intervening components) compliant springs 216A and 216B. Although a particular number and orientation of shock absorption springs is depicted in FIG. 2B, in other embodiments different quantities (e.g., more or fewer) of shock absorption springs may be at different orientations, including based on the number and shapes of mechanical and electrical anchoring portions. The shock absorption springs 222A/222B/222C/222D have a thickness and adjacent slotting that allows the springs to flex within the adjacent slotting when a shock (e.g., in any direction) occurs on the packaging of the MEMS accelerometer and is transmitted to the MEMS layer via the mechanical and/or electrical anchors. Accordingly, the force transmitted to the suspension springs 204A and 204B and proof mass 202 is limited by the shock absorption of the shock absorption springs 222A/222B/222C/222D.

FIG. 2C depicts a cross sectional view of the exemplary out-of-plane accelerometer 200 of FIG. 2A in accordance with an embodiment of the present disclosure. For ease of illustration, all components of the out-of-plane accelerometer 200 (e.g., of the anchoring region depicted in FIG. 2B, fixed MEMS layer portions, and proof mass within MEMS layer 232) are not specifically depicted in FIG. 2C, nor does FIG. 2C depict the encapsulation and interconnection of the MEMS layer 232, cover substrate layer 230, and base substrate layer 234. Although particular components are depicted in particular configurations in FIG. 2C, it will be understood that substitutions, additions, omissions, or other modifications may be made to FIG. 2C, for example, as described for FIGS. 2A and 2B.

FIG. 2C depicts a cover substrate 230 located above and parallel to MEMS layer 232 and a base substrate 234 located below and parallel to MEMS layer 232. The depicted thicknesses of the layers and distance between the layers is depicted for illustration only, and it will be understood that layer thicknesses and relative distances may be modified based on materials used, sensor type, etc. In the exemplary embodiment of FIG. 2C, cover substrate 230 does not include active electrical components or circuitry, while base substrate 234 includes active processing circuitry, including sense electrodes 236 and 238, as well as analog and digital processing circuitry (not depicted in FIG. 2C) such as amplifiers, filters, and digital processing circuitry. Accordingly, anchors 214A and 214B connecting the base substrate layer 234 to the MEMS layer 232 (e.g., at electrical anchoring portions 218A and 218B) provide electrical signals to the MEMS layer that are propagated through the MEMS layer, such as drive signals having a carrier frequency utilized for sensing movement of the proof mass 202 relative to the sense electrodes 236 and 238 (e.g., with differential out-of-plane movement of portions of the proof mass 202 relative to the sense electrodes 236 and 238). In the embodiment of depicted in FIG. 2C, mechanical anchors 212A and 212B also connect to the anchoring system 2B above the electrical anchors 214A and 214B (e.g., at electrical anchoring portions 218A and 218B), thus providing a mechanical connection to the cover substrate 230. As can be seen for mechanical anchor 210, which connects to the anchoring system 2B (e.g., at mechanical anchoring portion 211), there is no corresponding electrical anchoring portion connected to the MEMS layer 232 below the mechanical anchor 210.

FIG. 2D depicts a cross sectional view of the exemplary out-of-plane accelerometer of FIG. 2A subject to a shear force in accordance with an embodiment of the present disclosure. Components of FIG. 2D may be modified, for example, as described with respect to FIGS. 2A-2C. In the example depicted in FIG. 2D, shear forces 240 and 242 are applied to the MEMS accelerometer 200 in countervailing directions, with shear force 240 applied to cover substrate 230 in the positive y-direction and shear force 242 applied to base substrate 234 in the negative y-direction. The forces depicted are exemplary only, and it will be understood that forces may be experienced independently by any layers or substrate of the MEMS accelerometer 200 and in a variety of direction (e.g., within the x-y plane, and/or compressive z-axis forces). The exemplary shear forces 240 and 242 may correspond, for example, to shear forces that are experienced due to packaging with other components in end-use device, although it will be understood that a variety of root causes for shear and other forces can occur in different configurations and applications. It will be understood that the degree of lateral movement and tilt depicted in FIG. 2D may be emphasized for purposes of illustration, and that the lateral movement and tilt due to different forces experienced during operation may be substantially smaller than that depicted.

As is depicted in FIG. 2D, the directions of the countervailing shear forces 240 and 242 cause cover substrate 230 to shift laterally in the positive y-direction and base substrate 234 to shift laterally in the negative y-direction. These movements also impact the locations of the anchors connected to the respective layers/substrates. Mechanical anchors 212A and 212B are mechanically connected to the electrical anchors 214A and 214C via the MEMS layer 232 (e.g., via electrical anchoring portions 218A and 218B of the anchoring system 208 within the MEMS layer 232), such that the mechanical anchors 212A and 212B and electrical anchors 214A and 214B tilt with the lateral movement of the corresponding cover substrate 230 and base substrate 234. However, the mechanical anchor 210 translates laterally with the cover substrate 230 within the MEMS layer 232, causing corresponding components such as the fixed MEMS layer portions 206A and 206B and proof mass 202 to translate with the mechanical anchor 210 and cover substrate 230. Accordingly, while functional sensing components within the MEMS layer may translate laterally, they retain full coverage with sense electrodes 236 and 238 (e.g., based on relative sizing and locations of proof mass 202 and sense electrodes 236 and 238) without any change in the z-axis distance (e.g., corresponding to starting capacitance) between the proof mass 202 and sense electrodes 236 and 238.

FIG. 2E depicts a top view of an anchoring system of the MEMS layer of the exemplary out-of-plane accelerometer of FIG. 2A subject to the shear force of FIG. 2D in accordance with an embodiment of the present disclosure. As is depicted by upward and downward arrows superimposed at the electrical anchoring portions 218A and 218B, the MEMS layer associated with the electrical anchoring portions 218A and 218B tilts in response to the shear forces 240 and 242. However, the compliant springs 216A and 216B effectively absorb this tilt via the opposite-side connections between the electrical anchoring portions 218A and 218B with respect to mechanical anchoring portion 210. Accordingly, mechanical anchoring portion 211 does not tilt with the electrical anchoring portions 218A and 218B, but is allowed to move with the mechanical anchor 210 in the positive y-direction.

FIG. 2F depicts a top view of an anchoring system of the MEMS layer of the exemplary out-of-plane accelerometer of FIG. 2A subject to a shock force in accordance with an embodiment of the present disclosure. A shock force can be a result of a variety of underlying events and are typically encountered during use in an end-use device, such as dropping or some other impact. In the exemplary embodiment depicted in FIG. 2F, an example shock force 250 is depicted as being directed in the x-y plane (e.g., in the positive y-direction and negative x-direction), for example, due to an impact experienced at the upper left-hand corner of the end use device. As is depicted in FIG. 2F, the anchoring region 211 may temporarily shift in the direction of the shock force (e.g., depicted by movement mechanical anchor 210 and anchoring region 211 in the direction of the shock force). However, that movement is not translated to the active components such as fixed MEMS layer portions 206A and 206B, suspension springs 204A and 204B, and proof mass 202, based on the isolation slots 220A/220B and shock absorption slots 224A/224B/224C/224D collectively temporarily expanding or contracting along with shock absorption springs 222A/222B/222C/222D (e.g., as depicted in FIG. 2F with temporary changes as to the shapes and dimensions of these flexible components). After the shock force is absorbed by these components and is no longer impacting the MEMS accelerometer, the components within the anchoring system return to their original shape and position as depicted in FIG. 2A.

FIG. 3A depicts a top view of another exemplary anchoring system of a MEMS layer of an exemplary MEMS out-of-plane accelerometer 300 in accordance with an embodiment of the present disclosure. In the embodiment of FIG. 3A, most components are depicted in an identical manner as in FIG. 2B, and have the first reference numeral renumbered to begin with a “3” instead of a “2” (e.g., proof mass 202 is renumbered as proof mass 302, etc.). It will be understood that similar to FIG. 2B, in the embodiment depicted in FIG. 3A particular components may be added, removed, and modified in accordance with particular designs, configurations, and applications. Compared to FIG. 2B, in the embodiment of FIG. 3A the electrical anchoring regions 318A and 318B are anchored to only the electrical anchors 314A and 314B and via those anchors to the base substrate (not depicted in FIG. 3A). The electrical anchoring regions 318A and 318B are thus not directly connected to the cover substrate (e.g., via mechanical anchors similar to mechanical anchors 212A and 212B in FIG. 2B).

In the embodiment of FIG. 3A, the electrical anchoring regions 318A and 318B are thus less likely to experience stresses that resulting in a tilting of the electrical anchoring regions out of plane, such as shear forces that result in countervailing forces applied to the cover substrate above and base substrate below. In an instance of such a shear force, the portion of the force applied to the cover substrate would only be experienced in the x-y plane by the mechanical anchoring region 311 via mechanical anchor 310, and the countervailing force in the opposite direction would only be experienced in the opposite direction in the x-y plane by the electrical anchoring regions 318A and 318B via electrical anchors 314A and 314B. The respective in-plane forces are absorbed via compliant springs 316A and 316B, and thus are not translated between the mechanical anchoring regions 311 and electrical anchoring regions 318A and 318B, such that the active components of the MEMS accelerometer only shift with the mechanical anchoring region 311 as described herein.

FIG. 3B depicts a cross sectional view of the exemplary out-of-plane accelerometer including the anchoring system of FIG. 3A in accordance with an embodiment of the present disclosure. For ease of illustration, all components of the out-of-plane accelerometer 300 (e.g., of the anchoring region depicted in FIG. 3A, fixed MEMS layer portions 306A and 306B, and proof mass within MEMS layer 332) are not specifically depicted in FIG. 3A, nor does FIG. 2B depict the encapsulation and interconnection of the MEMS layer 332, cover substrate layer 330, and base substrate layer 334. Although particular components are depicted in particular configurations in FIG. 3B, it will be understood that substitutions, additions, omissions, or other modifications may be made to FIG. 3B, for example, as described for FIG. 3A.

FIG. 3B depicts a cover substrate 330 located above and parallel to MEMS layer 332 and a base substrate 334 located below and parallel to MEMS layer 332. The depicted thicknesses of the layers and distance between the lawyers is depicted for illustration only, and it will be understood that layer thicknesses and relative distances may be modified based on materials used, sensor type, etc. In the exemplary embodiment of FIG. 3B, cover substrate 330 does not include active electrical components or circuitry, while base substrate 334 includes active processing circuitry, including sense electrodes 336 and 338, as well as analog and digital processing circuitry (not depicted in FIG. 3B) such as amplifiers, filters, and digital processing circuitry. Accordingly, electrical anchors 314A and 314B connecting the base substrate layer 334 to the MEMS layer 332 (e.g., at electrical anchoring portions 318A and 318B) provide electrical signals to the MEMS layer that are propagated through the MEMS layer, such as drive signals having a carrier frequency utilized for sensing movement of the proof mass 302 relative to the sense electrodes 336 and 338 (e.g., with differential out-of-plane movement of portions of the proof mass 302 relative to the sense electrodes 336 and 338). In the embodiment of depicted in FIG. 2C, only one mechanical anchors 310 connects to the anchoring system at the mechanical anchoring portion of the anchoring system. Thus, the only anchored connections between MEMS layer 332 and base substrate 334 are to the electrical anchoring portions of the anchoring system via electrical anchors 314A and 314B, and the only anchored connection between the MEMS layer 332 cover substrate 330 is to the mechanical anchoring portion of anchoring system via mechanical anchor 310. In the configuration of FIGS. 3A and 3B, the behavior of the anchoring system will be similar to that described in FIGS. 2A-2F, except that some forces (e.g., shear forces) may be experienced differently by the anchoring system within the MEMS layer 232 but still absorbed by the compliant springs (e.g., in plane versus tilt).

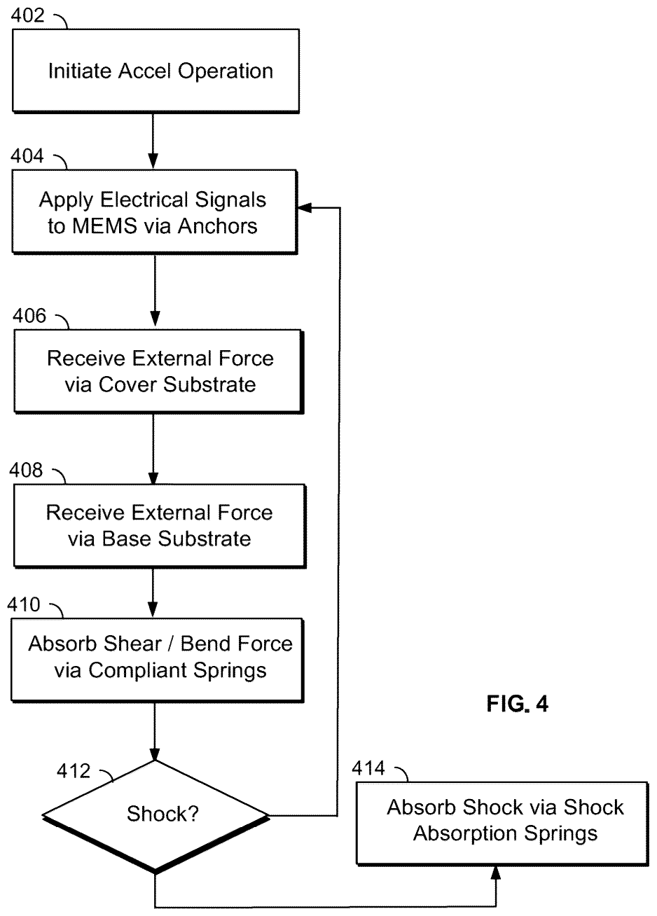

FIG. 4 depicts exemplary steps of operating an out-of-plane accelerometer having offset shift rejection in accordance with an embodiment of the present disclosure. Although particular steps are depicted in a certain order for FIG. 4, steps may be removed, modified, or substituted, and additional steps may be added in certain embodiments, and in some embodiments, the order of certain steps may be modified.

The steps of FIG. 4 begin at step 402, at which operation of a MEMS device such as an out-of-plane sensing MEMS accelerometer is initiated. For example, the operation of a MEMS accelerometer may be initiated with powering up of an end use device or may be generally active in a sleep or other low-power mode of the end-use device. In some instances, the sensing of the MEMS accelerometer may be based on a certain known or expected relative position of one or more proof masses relative to sensing components such as sense electrodes. Accordingly, certain scaling, offsets, amplification, conversion, and other operations of the MEMS accelerometer may be utilized for determining linear acceleration. Once the operation of the MEMS accelerometer is initiated, the steps of FIG. 4 can continue to step 404.

At step 404, electrical signals are applied to the MEMS layer of the MEMS accelerometer via the electrical anchors. As described herein, other layers of the MEMS accelerometer can include electrically active processing circuitry as well as sense electrodes. The processing circuitry can provide electrical signals such as electrical drive or carrier signals to the MEMS layer as well via the connections of the electrical anchors to the electrical anchoring regions of the MEMS layer. These signals in turn can propagate through the MEMS layer (e.g., to the fixed MEMS layer portions and proof mass) for use in sensing of motion or other purposes (e.g., self-test). Once the appropriate signals are propagated to the MEMS layer, the steps of FIG. 4 can continue to step 406.

At step 406, an external force such as a shear or shock force may be received or present within the MEMS layer via the cover substrate, such as via a mechanical anchor connecting the cover substrate to a mechanical anchoring region of an anchoring system of the MEMS layer. In some embodiments, the external force is also received within the MEMS layer via the cover substrate by mechanical anchors connecting the cover substrate to electrical anchoring regions of the anchoring system of the MEMS layer. The steps of FIG. 4 may continue to step 408.

At step 408, the external force may also be received or present within the MEMS layer (e.g., simultaneously) via the base substrate, such as via electrical anchors connecting the base substrate to the electrical anchoring regions of the anchoring system of the MEMS layer. The steps of FIG. 4 can continue to step 410.

At step 410, if received or present, forces such as a shear force may be absorbed by compliant springs connected between the mechanical anchoring region and the electrical anchoring regions. In an example where the electrical anchoring regions are anchored via both electrical anchors and mechanical anchors, the compliant springs may absorb a tilting within the MEMS layer of the electrical anchoring regions, while in an example where the electrical anchoring regions are coupled only to electrical anchors (i.e., only to the base substrate), the compliant springs may absorb a translation in plane between the electrical anchoring portions and the mechanical anchoring portion. Accordingly, the position of the active components of the MEMS accelerometer, which are only connected to the electrical anchoring portions indirectly via the compliant springs and mechanical anchoring portion, will only translate in plane with the mechanical anchoring portion in a manner that does not affect sense electrode coverage or the capacitive distance between the sense electrodes and the proof mass or fixed MEMS layer portions. The steps of FIG. 4 can continue to step 412.

At step 412, a shock force may be experienced by the sensor. It will be understood that there is no particular order of receiving a shock force versus a shear force, that such forces may be received simultaneously, and the particular ordering of FIG. 4 is for purposes of illustration only. If the shock force is not experienced, processing may return to step 402. If the shock force is experienced, processing may continue to step 414. At step 414, shock absorption springs that are located to suspend the active components of the MEMS accelerometer (e.g., between the mechanical anchoring portion and the fixed MEMS layer portions and proof mass) absorb the shock force such as by flexing in conjunction with adjacent slotting. In this manner, even though the mechanical anchoring portion may experience the shock force via its connection to the cover substrate via the mechanical anchor, the shock force does not get translated to the fixed MEMS layer portions or proof mass or is translated with a substantially reduced magnitude, preventing stress and damage to components such as by active in-plane components contacting each other, movable components contacting fixed components within the MEMS layer due to in-plane movement, or movable components contacting fixed components outside of the MEMS layer due to out-of-plane movement.

The foregoing description includes exemplary embodiments in accordance with the present disclosure. These examples are provided for purposes of illustration only, and not for purposes of limitation. It will be understood that the present disclosure may be implemented in forms different from those explicitly described and depicted herein and that various modifications, optimizations, and variations may be implemented by a person of ordinary skill in the present art, consistent with the following claims.

What is claimed is:

1. A microelectromechanical system (MEMS) sensor, comprising:
a cover substrate;
a base substrate;
a first anchor coupled to the cover substrate;
a plurality of second anchors coupled to the base substrate; and
a suspended spring-mass system within a MEMS layer positioned between the base substrate and cover substrate, the suspended spring-mass system comprising:
a proof mass;
a first anchoring portion coupled to the cover substrate via the first anchor;
a second anchoring portion coupled to the base substrate via a first one of the plurality of second anchors;
a third anchoring portion coupled to the base substrate via a second one of the plurality of second anchors, wherein the second anchoring portion and third anchoring portion are located on opposite sides of the first anchoring portion;
a first compliant spring connecting first anchoring portion to the second anchoring portion;
a second compliant spring connecting the first anchoring portion to the third anchoring portion; and
a plurality of shock absorption springs coupled between the first anchoring portion and the proof mass.

2. The MEMS sensor of claim 1, wherein the first anchor provides only mechanical anchoring to the first anchoring portion.

3. The MEMS sensor of claim 2, wherein a connection of the first anchoring portion to the first anchor has a circular shape or an oval shape.

4. The MEMS sensor of claim 1, wherein a second center point of the second anchoring portion and a third center point of the third anchoring portion are located equidistant from a first center point of the first anchoring portion.

5. The MEMS sensor of claim 4, wherein the second anchoring portion and the third anchoring portion have an identical shape and area.

6. The MEMS sensor of claim 5, wherein the identical shape is a rectangular shape or a square shape.

7. The MEMS sensor of claim 1, wherein the first compliant spring and the second compliant spring each have a lower stiffness than the plurality of shock absorption springs.

8. The MEMS sensor of claim 1, wherein the first compliant spring includes a first surrounding portion that surrounds the second anchoring portion and the second compliant spring includes a second surrounding portion that surrounds the third anchoring portion.

9. The MEMS sensor of claim 8, wherein the first compliant spring further comprises a first connection that connects the second anchoring portion to the first surrounding portion and a second connection that connects the first anchoring portion to the first surrounding portion, and wherein the second compliant spring further comprises a third connection that connects the third anchoring portion to the second surrounding portion and a fourth connection that connects the first anchoring portion to the second surrounding portion.

10. The MEMS sensor of claim 1, wherein the plurality of second anchors each provide an electrical connection from the base substrate to suspended spring-mass system.

11. The MEMS sensor of claim 10, wherein the base substrate comprises processing circuitry wherein the electrical connection is coupled to the processing circuitry.

12. The MEMS sensor of claim 11, wherein the processing circuitry comprises CMOS circuitry.

13. The MEMS sensor of claim 1, wherein the first anchoring portion comprises a first anchored portion directly coupled to the first anchor and a first surrounding shape, the second anchoring portion comprises a second anchored portion directly coupled to the first one of the plurality of second anchors and a second surrounding shape, and the third anchoring portion comprises a third anchored portion directly coupled to the second one of the plurality of second anchors and a third surrounding shape.

14. The MEMS sensor of claim 1, wherein the plurality of shock absorption springs are arranged at multiple locations around the first anchoring portion and equidistant to the first anchoring portion.

15. The MEMS sensor of claim 14, wherein each of the plurality of shock absorption springs are directly coupled to the first anchoring portion and extend adjacent to one of the first compliant spring or the second compliant spring.

16. The MEMS sensor of claim 15, wherein the plurality of shock absorption springs comprise four shock absorption springs, and wherein a first shock absorption spring extends from the first anchoring portion adjacent to a first side of the first compliant spring, a second shock absorption spring extends from the first anchoring portion adjacent to a second side of the first compliant spring, a third shock absorption spring extends from the second anchoring portion adjacent to a first side of the second compliant spring, and a fourth shock absorption spring extends from the second anchoring portion adjacent to a second side of the second compliant spring.

17. The MEMS sensor of claim 16, wherein the four shock absorption springs are arranged at 90 degrees with respect to each other.

18. The MEMS sensor of claim 14, wherein the plurality of shock absorption springs are arranged symmetrically around the first anchoring portion.

19. The MEMS sensor of claim 14, wherein each shock absorbing spring of the plurality of shock absorbing springs is compliant to a force between the first anchoring portion and the proof mass when the MEMS sensor is exposed to a shock.

20. The MEMS sensor of claim 14, further comprising a plurality of sense springs that couples the proof mass to the plurality of shock absorption springs.

21. The MEMS sensor of claim 1, wherein each of the first compliant spring and the second compliant spring reduce the a shear force transfer between the first anchoring portion and each of the second anchoring portion and third anchoring portion.

22. The MEMS sensor of claim 1, wherein the first compliant spring surrounds the second anchoring portion and connects the first anchoring portion to the second anchoring portion, and a second compliant spring surrounds the third anchoring portion and connects the first anchoring portion to the third anchoring portion.

23. The MEMS sensor of claim 1, wherein the MEMS sensor comprises a z-axis accelerometer, and wherein the proof mass is configured to move out of plane in response to a linear acceleration force in a z-axis direction.

24. The MEMS sensor of claim 1, wherein the MEMS sensor comprises an x-axis or y-axis accelerometer, and wherein the proof mass is configured to move in plane in response to a linear acceleration force in a x-axis or y-axis direction.

25. The MEMS sensor of claim 1, wherein the MEMS sensor comprises any of a gyroscope, pressure sensor, magnetometer or a microphone.

26. The MEMS sensor of claim 1, wherein at least one of the plurality of second anchors is connected to the cover substrate.

27. A microelectromechanical system (MEMS) sensor, comprising:
a cover substrate;
a base substrate;
a first anchor coupled to the cover substrate;
a plurality of second anchors coupled to the base substrate; and
a suspended spring-mass system within a MEMS layer positioned between the base substrate and cover substrate, the suspended spring-mass system comprising:
a proof mass suspended from the first anchor and second anchor via one or more springs;
a first anchoring portion coupled to the cover substrate via the first anchor;
a second anchoring portion coupled to the base substrate via a first one of the plurality of second anchors;
a third anchoring portion coupled to the base substrate via a second one of the plurality of second anchors, wherein the second anchoring portion and third anchoring portion are located on opposite sides of the first anchoring portion;
a first compliant spring of the one or more springs surrounding the second anchoring portion and connecting first anchoring portion to the second anchoring portion; and
a second compliant spring of the one or more springs surrounding the third anchoring portion and connecting the first anchoring portion to the third anchoring portion.

28. A microelectromechanical system (MEMS) sensor, comprising:
a cover substrate;
a base substrate;
a first anchor coupled to the cover substrate;
a plurality of second anchors coupled to the base substrate; and
a suspended spring-mass system within a MEMS layer positioned between the base substrate and cover substrate, the suspended spring-mass system comprising:
a proof mass;
a first anchoring portion coupled to the cover substrate via the first anchor;
a plurality of second anchoring portions coupled to the base substrate via a respective one of the plurality of second anchors;
a shear reduction means for isolating the first anchoring portion from a shear force at the plurality of second anchoring portions; and
a shock absorption means located between the first anchoring portion and the proof mass for absorbing a shock force at the first anchoring portion.
